(19) United States
(12) Patent Application Publication
(10) Pub. No.: US 2015/0352007 A1
(43) Pub. Date: Dec. 10, 2015

(54) An Intradermal Needle

(71) Applicant: ACUREGEN LIMITED, London (GB)

(72) Inventor: Amanda Ira Shayle, London (GB)

(21) Appl. No.: 14/761,420

(22) PCT Filed: Jan. 15, 2014
(86) PCT No.: PCT/GB2014/000015

§ 371 Date: Jul. 16, 2015

(30) Foreign Application Priority Data
Jan. 16, 2013 (GB) 1300744.8

(51) Int. Cl. A61H 39/08

(52) U.S. Cl. CPC A61H 39/086

(57) ABSTRACT

Intradermal needles are commonly used in cosmetic procedure to improve the skin, for example to activate cellular processes such as induction and regeneration of some of the superficial levels of skin, such as collagen. The present invention discloses an intradermal needle comprising: a shaft, an insertion tip and a handle wherein handle depth is greater than shaft gauge so that the handle is spaced apart from skin when inserted allowing the intradermal needle to be easily inserted and removed.

### FIELD OF INVENTION

A needle particularly but not exclusively an intradermal needle that is intended to be clearly visible in use, for example as desired by complementary and alternative medical practitioners, such as those practicing acupuncture.

### BACKGROUND

The use of needles to elicit health benefits has long been established, in particular for use in the field of acupuncture. Evidence has shown that the size of needle is varied in order to obtain different results or to suit different locations.

The use of some types of needles—often referred to as micro needles—(or intradermal needles) is a commonly used cosmetic procedure to improve the skin, for example to activate cellular processes such as induction and regeneration of some of the superficial levels of skin, such as collagen.

Typically specialist needles such as Japanese needles are provided for such procedures. Due to the small size of the needles they are always inserted by use of tweezers. However additional skills and techniques may be required in order to insert the needles by this method.

Additionally the micro needles are of such small dimensions they are difficult to identify in use therefore making them harder to handle and extra care must be taken to ensure all are removed at the end of a session of treatment, in order to avoid injury or discomfort to the patient. In particular facial work involving micro needles is of high risk as micro needles may accidentally drop from the tweezers onto the face during insertion and/or removal.

### PRIOR ART

Use of intradermal needles for health benefits is documented extensively in particular in Chinese and Japanese medicine.

Finer needles have been developed for this purpose such as Seirin (Trade Mark) needles wherein their finest gauge needles, typically 0.12 mm, are for intradermal use and include a coiled handle that is held between tweezers for insertion due to the small size of their handle. Traditionally the Seirin (Trade

Mark) needles are intended to be retained embedded in the patient's skin for several days therefore there is a requirement for discrete sizing.

Japanese-style needles, such as Qi (Trade Mark) intradermal 0.16 mm gauge needles, are available in 3 mm and 6 mm lengths with coiled handles and these are typically much finer than Chinese needles. These Japanese-style needles are most commonly favoured in 0.16 mm gauges with longer shaft lengths of 30 mm and 15 mm. These longer needles are also usually silicon-tipped which enables easy insertion into facial tissue.

The benefits of use of micro-needling which employs a roller with a plurality of micro needles (intradermal needles) such as a ‘dermaroller’ (Trade Mark) is well documented, wherein the dermaroller (Trade Mark) is rolled over the skin to perform micro-needling over an area of skin.

Russian patent SU-A1583803 discloses a modified acupuncture needle with a flat wire spiral handle that is inserted at specified angle and held for extended period.

Japanese patent application JP 02098950U reveals a press needle for retention.

United States patent U.S. Pat. No. 5,540,710 shows a needle assembly for performing acupuncture treatment including a holder and a needle.

Japanese patent application JP-S-5466693U discloses a needle for retention having a flat handle.

TeWa (Trade Mark) Intradermal needles disclose an intradermal needle with a foam ‘tab’ with each needle, making it easier to find if dropped and the tabs are colour coded.

A problem associated with these prior art devices is that they have tended to comprise very small needles that are not easily visible against the skin and which need a tool for removal, replacement and reinsertion and this has been time consuming and can lead to contamination of the tool.

An aim of the present invention is to overcome the aforementioned problems by providing an improved needle.

### SUMMARY OF INVENTION

According to the present invention there is provided an intradermal needle comprising: a shaft, an insertion tip and a substantially planar handle wherein the handle has a greater depth than shaft gauge so as to space apart the handle from the skin when the needle is inserted at any orientation whereby in use the needle is prevented from lying flat on the subjects skin.

The advantage of not lying flat against a patient's skin is that the needles can be easily removed from the skin. Aided by the fact that the handle sits slightly proud of the skin. Another advantage of being prevented from lying completely flat against the skin is that the needles can be arranged in close proximity to one another in order to achieve maximum health benefits without projecting significantly from the skin whereby they may be easily caught or knock when a practitioner is working.

In this way the intradermal needle can be easily be inserted to and removed from the skin by holding the handle during insertion.

Preferably the shaft, handle and tip are arranged coaxially and the shaft is arranged centrally from the handle. Therefore as the handle has a greater fundamental dimension depth than shaft gauge the handle is always slightly raised from the skin to aid insertion and removal of the intradermal needles. In this way even if the intradermal needle is inserted at an angle whereby the handle lays close to the skin it can never be flush to the skin due to the ‘chunky’ handle.

In preferred embodiments the intradermal needle is for use with cosmetic treatments on various skin types and regions of the body where the intradermal needles may be used for cosmetic benefit being inserted so as to be positioned between layers of dermis (skin).

Preferably the intradermal needle is formed entirely from metal such as aluminium, stainless steel or surgical steel and most preferably from high grade metals suitable for surgical/medical use, such as Japanese steel

Preferably the intradermal needles may be formed from two pieces of metal, the shaft and the handle, which are joined together during manufacture. Alternatively the needles may be formed from a synthetic plastics material which may also be colour-coded.

According to another aspect of the present invention there is provided a method of manufacturing an intradermal needle comprising the steps of: shrouding a shaft with a shroud which when crimped fixes the shaft within the shroud which becomes the handle.

Typically the shroud is tubular so as to be capable of receiving the shaft before crimping.

In preferred embodiments the intradermal needles are anticipated to be for single use or repeated use during one treatment wherein the intradermal needles are provided sterilised and ready for treatment.

Advantageously the intradermal needle may readily adapt to the temperature of the user and the patient so that heat is conducted from the user or practitioner's fingers, through the needle. It is envisaged that other materials with similar properties may be used to enhance user benefits, such as solid gold or silver, or gold or silver plated intradermal needles which may have different benefits such as high energetic potential and the potential for helping to improve “patient's energy” and well-being. Furthermore magnetic metals or alloys or coloured metals may be used to differentiate needle types and/or lengths of needles.

In further embodiments at least a portion of the intradermal needle may be formed from a ferromagnetic material so as to be magnetic in order to further enhance the treatment benefits. For example, once needles are inserted in to the skin these may be moved by a magnetic field so as to stimulate tissue and blood flow. Movement of needles may be measured and monitored for example in order to vary stimulation. It may be envisaged that the intradermal needles may be stimulated by a magnetic tool, such as magnetic pick-up tool that is wave over the needles in order to cause movement.

Advantageously by having magnetic needles the pick-up tool may be used to pick up needles, for example if they are dropped.

In preferred embodiments the handle is a parallelepiped portion so as to be clearly visible on the intradermal needle end and to enable the handle to be easily held in the user's finger tips or between tweezers. Ideally the parallelepiped portion has rounded or chamfered edges, to ensure there are no sharp edges that may be exposed to the user or patient. Alternative shaped handles include: a cube, a block, a cylinder or a barrel.

In preferred embodiment the handle is solid, not having gaps or openings so that it is clearly visible against the skin. For example the handle may appear as a block of colour against the skin thereby being clearly visible.

Ideally the handle dimensions are at least 1.5 mm×2.5 mm×0.5 mm and more preferably 1.5 mm×3 mm×0.5 mm. Typically the intradermal needle handle is no greater than 4 mm×8 mm×1 mm.

Therefore handle size is always small by comparison to standard acupuncture needles. Advantageously his allows multiple intradermal needles to be inserted in close proximity to one another with lesser risk of a practitioner knocking needles which are already inserted as they no not extend far from the skin. In this way the user has greater freedom of movement when inserting closely arranged needles, in particular for example when arranging needles around the eyes such as following a wrinkle line which may involve insertion of multiple needles at varying angles along the wrinkle.

Advantageously the needles allows for the use of facial treatment such as creams, tonics, face cloth and facemasks to be placed over and about the inserted needles. For example a cream may be applied over and around the intradermal needles to provide additional benefits during treatment or a cover may be laid over the needles such as a cloth or flannel. As the intradermal needles do not project far from the skin it is possible to apply the facial treatment over and about the intradermal needles. Furthermore as the handle is always spaced apart from the skin it is possible for the facial treatment to contact the skin about the needle insertion point, thus providing improved benefits.

Additionally, treatments such as addition of a face mask such as an herbal compound or may be readily applied around the intradermal needles as the user is freer to work around the inserted intradermal needles whereas longer acupuncture needles must be removed first to enable the user to be able to apply the face mask. Furthermore due to the small size of the intradermal needles impregnated gauze may my laid over the skin where needles are inserted for further benefits to the patient

Furthermore the short handles provide improved balance to the needle and less weight so that they are held in the skin better during use. Longer needles tend to droop if they are not inserted to a particular depth and it may not be suitable to enter needles to such a depth on particular parts of the face. The short length of the needle shaft also guarantees that they cannot be inserted too deep so there is less room for practitioner error.

In some embodiments the handle may be stepped so to as to have a raised portion at a proximal end to which a practitioner may use to aid with grip.

In other embodiments the handle may be teardrop shaped or triangular so as to be widest at the location at which the handle is held by the user and being narrowest where the handle is closest to the skin. For example a cross section of the handle may taper towards the shaft.

In some embodiments the handle may be curved about a longitudinal/transverse axis so assisting the user to hold the needle accurately and insert the intradermal needle. Typically at least one face of the handle may be arcuate so as to distinguish one face from another making the handle easier to grip and less likely to slip in use. Additionally to enable optimal use of the intradermal needles with tweezers at least a portion of the handle must be flat.

Preferably the intradermal needle and particularly the handle is substantially planar thereby enabling the intradermal needle to be laid near flat against the patient's skin when inserted in some orientations, thereby being less likely to be knocked or dislodged in use. As the handle has a depth greater than shaft gauge the intradermal needle is unable to sit entirely flush to the skin even when inserted in such a way that the handle is near parallel to the skin. Therefore the intradermal needles may be easily inserted and retrieved. In particular this enables the intradermal needles to be inserted by hand, which is not possible with many existing intradermal needles.

Advantageously numerous intradermal needles may be readily inserted in close proximity without risk of knocking needles which have already been positioned therefore avoiding the potential risk of causing discomfort for the patient.

This may enable an increased numbers of needles to be used in the treatment therefore creating an increased number of micro channels within the dermis, for example on a wrinkle line or furrow on the skin thereby leading to enhanced benefits such as induced collagen production.

Additionally the intradermal needles may remain in situ for periods of time for enhanced benefits, for example several hours and due to the size of the intradermal needles the patient is able to move around if required with minimal risk of dislodgement to the needles.

Some existing needles may be left in over night wherein they may be covered for protection or may include a barb so as to be retained without requirement to be covered. Such needles are designed to lie completely flush against the skin making them difficult to remove and often limiting the insertion of other needles in very close proximity due to the surrounding area being blocked by the needle handle. Furthermore such needles can be difficult to identify against the skin therefore making them riskier to use in sensitive areas such as around the eyes or on contoured skin such as in wrinkled or scarred skin.

Some prior art needles suitable for being retained are inserted with a plunger and are designed to be retained with a barb for up to a week, typically being taped down.

However, the intradermal needle of the present invention may remain in place without requirement for covering for example with tape due to their small size and typically are not intended to remain in the skin over night but instead to be used for the duration of a cosmetic acupuncture session, for example around 1.5 hours maximum with needles typically being in the skin for up to 40 minutes.

Advantageously the intradermal needle handle enables the intradermal needle to be easily held and inserted or removed by hand rather than to use an additional tool, such as tweezers accurately to insert or remove the needle.

This is particularly advantageous when working around some areas such as the patients eyebrows where the handle remains visible and may be readily removed by hand so as to limit accidently plucking a hair whilst removing needles.

The intradermal needle has particular benefits for training users to insert the intradermal needles, as when inserting standard needles this may be readily done by hand whereas use of the smaller intradermal needles requires additional techniques such as the use of tweezers, in particular as the risk of needles being dropped are higher.

A designated location on the handle is optionally provided so that a user can hold the handle and insert the intradermal needle at the desired orientation, for example a visual indicator such as a line or groove may be provided to guide the user where to place their finger tips or tweezers on the handle so as to best insert the needle with minimal risk of the tweezers or finger tips coming into contact with the patient.

Although the user wears gloves during treatments and tweezers may be readily cleaned, it is common for the patient's skin to bleed in response to the needle during treatment and therefore blood may be transferred to the tweezers or finger tips during treatment which is undesirable. The handle serves to limit the opportunity for direct contact with the patient's skin, therefore being more hygienic.

In preferred embodiments the handle is coaxial in relation to the shaft and insertion tip.

In some embodiments the handle may be angled with respect to the shaft so as to facilitate easier insertion for some locations and orientations. For example the handle may be attached to the shaft at an angle of 45 degrees to enable insertion of intradermal needles into parts of the body that may be less accessible, such as the side of the face, without requirement to move the patient or for the user to substantially change their stance which may affect the balance of the practitioner.

Preferably the handle may be coloured so as to be easily distinguishable from the skin and other needles. By colouring the handles, the needles are more easily identified on the skin and therefore the risk of erroneously leaving one in the skin is reduced. Also as the handles stand out so clearly, it is easier for the user to observe the area treated and for them to identify regions which may have been missed during the treatment, to then treat these regions so as to ensure maximal. The handles being clearly visible has particular benefit in areas of facial hair such as eyebrows or male facial hair.

Typically the shrouds may be available in various materials in order to change the appearance of the handle when manufactured so that the practitioner can easily distinguish between needles. For example the handle material may determine needle length, gauge or whether the needle tip is coated in a lubricant.

Ideally the shrouds used for different intradermal needles may be formed from materials that are visually different to aid in distinguishing the needles.

Preferably the shrouds may be of different metals, for example gold, surgical steel and copper, therefore each handle is a different colour, gold, silver and copper.

It may be envisaged that in some embodiments the shroud is coated in order to distinguish one needle type from another.

This is particularly beneficial as some prior art needles are formed from two or more materials—such as plastics and metal—joined together. An advantage of such a composite needle is that the intradermal needle is more hygienic, for example reducing the chance of bacteria collecting where the materials join, such as where a plastic handle joins a metal shaft.

In some embodiments the intradermal needles may be formed from other metals or metal alloys which may also have additional health benefits during treatment as well as enabling the needles to be readily distinguished from one another.

In particular the shaft may be formed from a specific metal such as gold, silver or copper, the shaft being the part of the needle that directly interfaces the skin. The handle may be coloured and formed from a different metal.

Furthermore use of different types of needles, distinguished by colour enables the practitioner to record exact treatment details, such as which needle and the number of needles used at particular locations. For example shorter needles may be used around the mouth which may be more sensitive. After repeated treatments they may become less sensitive and be able to use a longer needle for greater stimulation.

Additionally or alternatively the handle may be provided with different patterns in on different shapes, so as to represent different needle types, length or gauge so that the user may easily identify which type or size of intradermal needle they are using.

In preferred embodiments the intradermal needles are provided in a range of sizes such as a small, medium and large, wherein handle size remains constant but shaft length varies.

Preferably handle dimensions are 1.5 mm×3.0 mm×0.5 mm. Typically handle dimensions remain consistent on different types of the intradermal needle so that the practitioner can handle all types of needles in the same manner, therefore improving the treatment.

In a much preferred embodiment the needles may be distinguished by their colour or the material from which they are formed. For example gold, silver and copper needles may be provided wherein:
A gold intradermal needle is formed using a gold shroud having a usable shaft length of between 2 mm and 12 mm wherein the shaft is formed from surgical steel.
A silver intradermal needle has an aluminium shroud and a usable shaft length of between 2 mm and 12 mm.
A copper intradermal needle has a copper shroud used to form and a useable shaft length of between 2 mm and 12 mm.

The useable shaft length is defined as the length of shaft extending from the handle after manufacture.

It may be envisaged that the needles may be formed from a material such as gold, silver or copper, may be coated in a material such as gold, silver or copper or may be coated in a material so as to give the appearance of being coloured such as being coloured gold, silver or copper.

In some embodiments only the handle may be coated so as to be coloured.

Therefore a range of the above described needles may be used in a single treatment to allow for variation in the skin type such as wrinkle depth, scarring or pitting. Each of the needles is clearly distinguishable by colour therefore the practitioner becomes intuitively aware of needle length by colour.

Additionally the handle may be textured for example to include ridged or pitted surfaces to improve grip and limit slippage whilst in use. It may be that only one of the faces of the handle is textured, although two or more faces may be textured if the handle has a triangular or square cross-section.

In preferred embodiments the shaft is dimensioned for particular regions of the dermis. Ideally various shaft lengths are provided, preferably including a range of lengths of at least 3 mm and no greater than 10 mm so as to provide a predetermined length that can be partially or fully inserted into the patient's skin.

Some micro-needling such as by use of the dermaroller (RTM) may use needles of very short lengths from 0.2 mm up to 2.5 mm although these may not be long enough to pierce the skin to sufficient depth for uneven, scarred or pitted regions of skin and therefore these regions of skin remain untreated. An individual intradermal needle of at least 3 mm will be able to overcome skin abnormalities and can be precisely positioned to target for example a scar to enhance a healing cascade which encourages activity of macrophages and other cellular cascades to clear away scar tissue.

Preferably the intradermal needle gauge is no greater than 0.18 mm and ideally no less than 0.10 mm for optimal ease of insertion and to elicit the desired health benefits. Most preferably the gauge of the intradermal needle is 0.12 mm so as to cause minimal discomfort and bruising to the patient whilst leading to maximal benefits.

Advantageously the small gauge of the intradermal needle reduces the likelihood of bruising and makes them easier to insert into scarred tissue such as acne affected skin.

Ideally the insertion tip of the intradermal needle may be coated in a lubricant such as a silicon based compound in order to reduce friction or where there may be skin resistance such as scarred skin, so as to easier facilitate insertion. The silicon coating aids insertion of the needle into the skin, reducing associated sensation such as pain and therefore improving the experience for the patient.

In some embodiments the entire intradermal needle may be silicon coated however this may be dependent on if the handle is coated, for example intradermal needles with coloured handles may not be coated in silicon so as not to react with the colouring.

Furthermore the insertion tip preferably has a central round point tip wherein the tip is at least double polished for optimal sharpness and therefore improved ease of insertion to the skin.

In preferred embodiments the intradermal needle is stored in a pad wherein the insertion tip is positioned within the pad so that each needle may be stored/packaged separately. Advantageously the pad can be picked up with finger and thumb and the needle extracted safely with the other hand, therefore reducing danger of the needle flicking out of the packaging near the patient's face or being lost on the treatment surface or on the floor.

In some preferred embodiments a plurality of needles may be stored in a cartridge that can be arranged on a practitioner in use to aid with dispensing of multiple needles during a treatment.

The cartridge for storing a plurality of needles is capable of being mounted on a wristband for donning by a practitioner to aid in dispensing of the needles during a treatment.

Preferably the needles may be stacked within the cartridge so that the handles are arranged to be easily assessable to the practitioner. For example the cartridge may house 2 rows of needles. Typically the needles are arranged in at least one pad so that the handles are readily accessible from the cartridge.

Ideally the cartridge is adapted to be connected to a wristband so that the cartridge can be arranged on the practitioner's wrist in use thereby by keeping their hands free for handle the needles therefore improving hygiene by limiting surface with which the needles come into contact.

In preferred embodiments the cartridge includes a clip that is accepted to a corresponding connector on the wrist band. In this way the cartridges are provided separately can be replaced when all needles have been used or if an alternative type or sized needle is required.

In other embodiments the cartridge may be connected to the wristband by hook and loop means, magnets, push fitting or a detent mechanism.

The wristband preferably includes a body for receiving the cartridge and at least one strap for wrapping about the wrist. Preferably the body includes 2 pairs of straps that extend about the wrist and are secured at distal ends.

In some embodiments the pad may be impregnated with silicon so as to silicon coat the tip to improve insertion into the skin.

Typically each needle and pad may be supplied in a specially designed or patterned package for storing in an individual blister arranged on a strip.

Thereby only the required needles may be removed from the packaging to reduce wastage.

Accordingly, the strip may be colour coded to the intradermal needle colour for ease of identification or additionally or alternatively the strip may include the intradermal measurements printed on the strip.

Ideally needles and pads may be visible through a transparent front provided on the packaging so that individual blisters can be opened for optimal safety and hygiene when removing needles for use.

Preferably multiple sheets of needles may be provided in one box, most preferably more than 100 or more preferably more than 200 needles may be provided per box or package, so as to provide sufficient needles for use or treatment.

Ideally the needles are sterilised before packaging and then the packaged needles go through a further sterilisation process. Preferably the needles are manufactured and packaged in a pyrogen free environment so as to prevent the deposition of destroyed bacteria and other agents on the needles or packaging as a result of sterilisation as sterilisation alone will ensure the absence of viable living bacteria however it will not eradicate the residue from the destroyed bacteria.

In some embodiments the needle is manufactured as a single piece having no welds or joints, for example the needle may be pressed or drawn.

In other embodiments the intradermal needle may be formed from more than one part being threaded, joined or welded to provide a complete needle. For example the shaft may be inserted and set into the handle.

Additionally the intradermal needle may be coated for example being dip, sprayed or powder coated so as to adjust the exterior finish, such as for plating, colouring the handles or coating the insertion tip.

A wet cover may be used over the needles to cool a patient's skin so as to assist in cooling or easing any discomfort.

Preferred embodiments of the invention will now be described by way of example only and with reference to the Figures in which:

### BRIEF DESCRIPTION OF FIGURES

FIG. 1A shows an overview of an intradermal needle;

FIG. 1B shows a side view of the embodiment shown in FIG. 1;

FIG. 1C shows a side view of the embodiment shown in FIG. 1 wherein the handle includes a groove;

FIG. 2A shows an end view of the handle;

FIG. 2B shows an end view of an alternative embodiment of a curved handle;

FIG. 3 shows an image of a patient's face illustrating a plurality of intradermal needle inserted into the patient's face;

FIG. 4A shows an intradermal needle with an angled handle;

FIG. 4B shows as side view of the needle in FIG. 4A with an angled handle;

FIG. 5 shows an overall view of a further alternative embodiment of the intradermal needle fitted with a ‘teardrop’ shaped handle;

FIG. 6 is an overall view of an example of an intradermal needle with a gold handle;

FIG. 7 is an overall view of an example of an intradermal needle with a silver handle;

FIG. 8 is an overall view of an example of an intradermal needle with a copper handle;

FIG. 9 shows an overall diagrammatic view of a cartridge for use with a wristband in dispensing needles;

FIG. 10 shows an overall diagrammatic views of a wristband for receiving the cartridge; and

FIG. 11 shows the wristband and cartridge in use on a user's arm.

### DETAILED DESCRIPTION OF PREFERRED EMBODIMENTS OF THE FIGURES

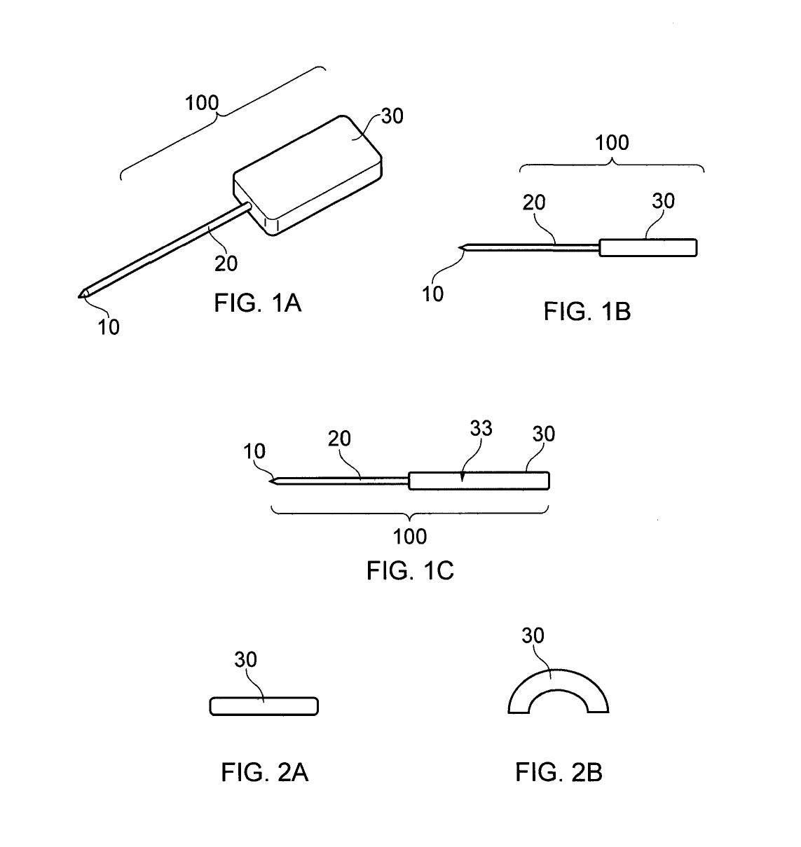

FIG. 1A shows an overview of an intradermal needle 100 comprising: an insertion tip 10, a shaft 20 and a handle 30, wherein the insertion tip 10, shaft 20 and handle 30 are coaxial.

The handle 30 is planar being parallelepiped in shape and has rounded corners so as to be readily held by the user and clearly visibly on the patient when in use. Ideally the handle 30 is dimensioned to be 1.5 mm×3.0 mm×0.5 mm.

The shaft 20 is positioned centrally on the handle 30 end assisting the user to accurately insert the intradermal needle 100. FIG. 1A shows the shaft 20 is dimensioned so as to be longer in length than the handle 30 (3 mm) although in other embodiments the shaft 20 and handle 30 may be of equal length to the shaft 20 may be shorter in length than the handle 30.

The handle 30 preferably remains the same size regardless of shaft 20 length. Therefore the user experience is consistent and the handle 30 sizing enables the user to work in close proximity to the skin and surrounding needles regardless of length or gauge of the needle.

FIG. 1b shows the side view of the above mentioned intradermal needle 100 revealing a handle 30 thickness greater than the gauge of the shaft 20. Ideally the handle 30 thickness is at least 0.5 mm and no greater than 1 mm. The handle depth is ideally at least 0.5 mm enabling the handle 30 to be felt between the users finger tips so that it may be easily gripped for use and manoeuvred for insertion/removal.

As the thickness of handle 30 is typically greater than the shaft this provides an improved method of manufacture over alternative dimensions wherein the shaft may be of greater gauge than the handle 30 thickness.

FIG. 1C shows an intradermal needle 100 wherein the handle 30 has a groove 33 so as to guide the user as where best to hold the needle or position the tweezers. Additionally the groove 33 provides a location where the tweezer tips may sit without slipping during use.

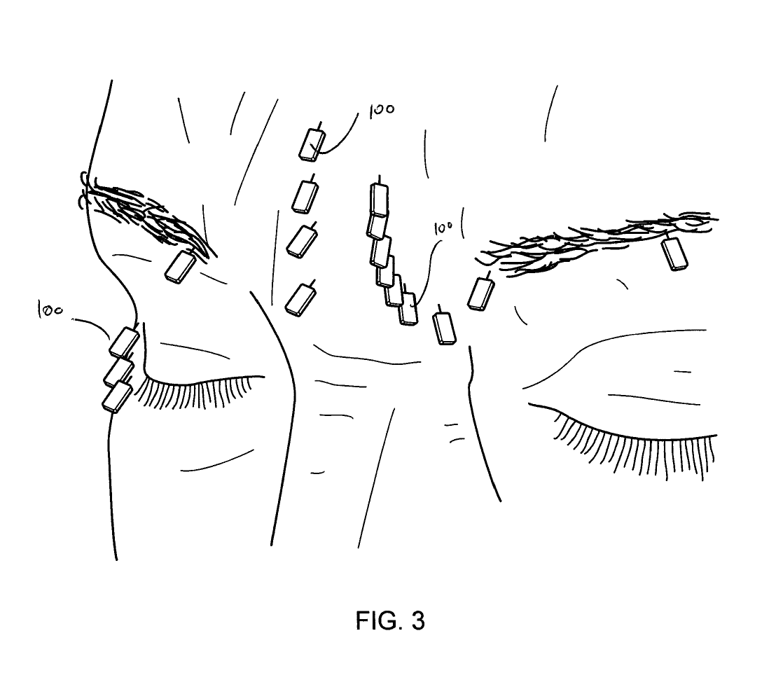

FIGS. 2A and 2B show end of views of the handle to reveal two different embodiments. In 2A the handle 30 is planar ideally dimensioned to a width of at least 2.5 mm so as to be distinguishable between the user's finger tips.

FIG. 2B shows an intradermal needle with a curved handle wherein the parallelepiped faces are arcuate, being substantially parallel, thereby defining a top and a bottom of the handle 30. The curved faces enable the handle to be readily gripped by the user.

Alternatively only one surface may be arcuate or angled wherein the second surface is planar thereby providing a semi-circular or triangular profile.

FIG. 3 reveals a photograph of a patient with a plurality of needles inserted into the skin on their face. The picture shows use of standard longer acupuncture needles 200 being used on the face alongside the smaller intradermal needle 100, and Japanese Qi needles 250.

The reduced shaft 20 length of the intradermal needles 100 combined with the smaller but clearly visible handle 30 enables easy placement of other needles in close proximity. The arrangement of the intradermal needles 100 when in place can also be readily viewed by the user which can be useful to aid the user in following a particular line such as a wrinkle or muscle.

Additionally the surrounding needles are less likely to be knocked during insertion as the handle lies close to the patient's skin when inserted rather than extending where it may be easily knocked. Therefore the user is able to work freely to insert other needles and apply further treatments such as facemasks with minimal risk of interference to other needles and without the necessity to remove acupuncture needles 200 in order for the further treatments to be carried out so as to enhance the benefits of the session of treatment.

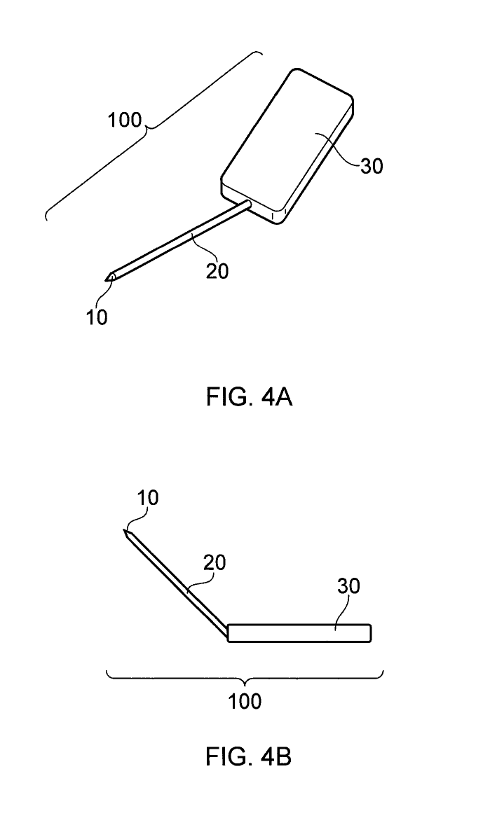

FIGS. 4a and 4b reveal an intradermal needle 100 with an angled handle 30. The handle 30 is angled at 45 degrees to the shaft 20 to enable the intradermal needle 100 to be more easily positioned for insertion between dermal layers. In particular in regions of the skin with varied skin shape such as the face where the user may be required to insert needles at various orientations in close proximity for example around the patients eyes.

The handle 30 may be provided at any angle between 0 and 90 degrees in order to optimise ease of use.

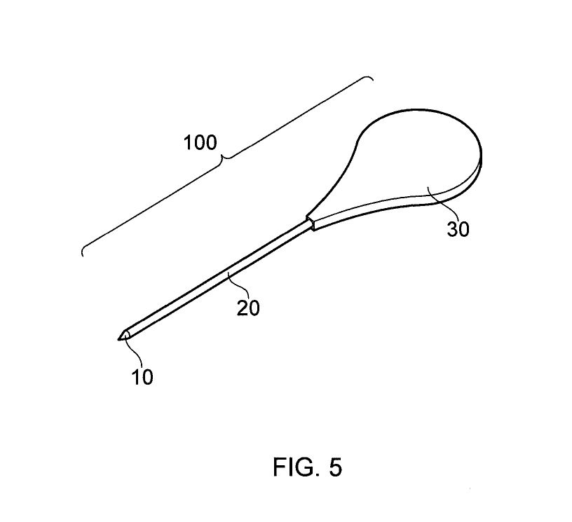

FIG. 5 shows an intradermal needle 100 with a teardrop shaped handle 30. Typically the handle 30 has a maximum width of 4 mm and tapers towards the shaft so as to be easy to insert multiple needles in close proximity.

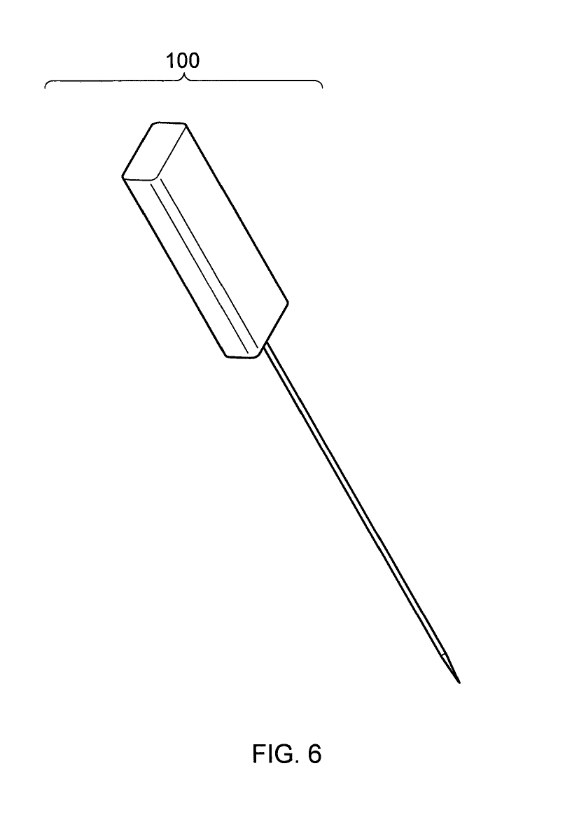

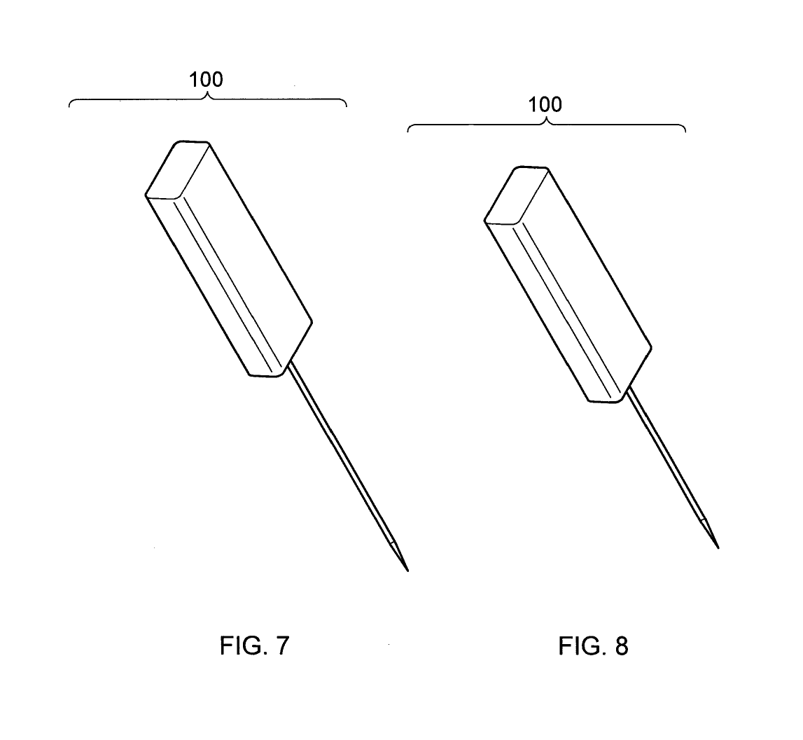

FIGS. 6-8 show preferred embodiments of the intradermal needles that may be provided as a set allowing the practitioner choice of shaft length that can be clearly identified by colour of the intradermal needle handle. In each embodiment handle size remains the same but shaft length varies.

The handle has dimensions of 1.5 mm×3.0 mm×0.5 mm. Optionally handles may be distinguished by forming them in different lengths, for example, the gold intradermal needle may have a shaft length of at least 4 mm; the silver intradermal needle may have a shaft length of at least 3 mm; and the copper intradermal needle may have a shaft length of at least 2 mm.

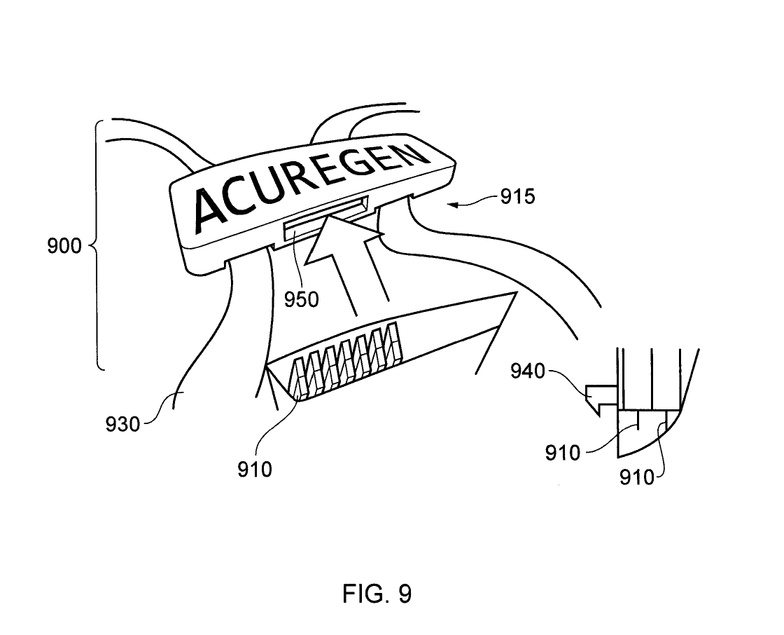

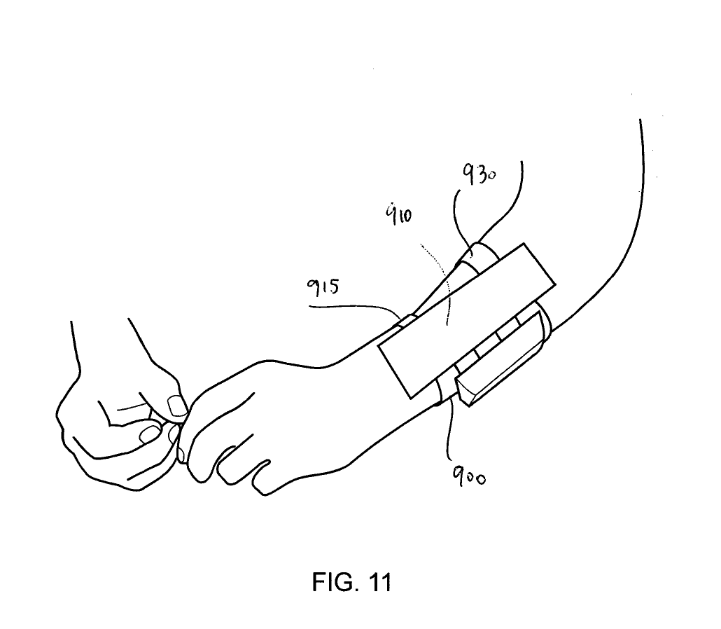

FIGS. 9, 10 and 11 show a needle dispensing means comprising a wristband 900 and a cartridge 910. In this way a practitioner can readily remove needles from the cartridge located on the practitioner's wrist and then insert them into the skin.

The cartridge has an opening 915 through which the needles are accessed. The needles are stacked in rows which the needle shafts being arrange in a pad 920 in order to secure them in position within the cartridge 910.

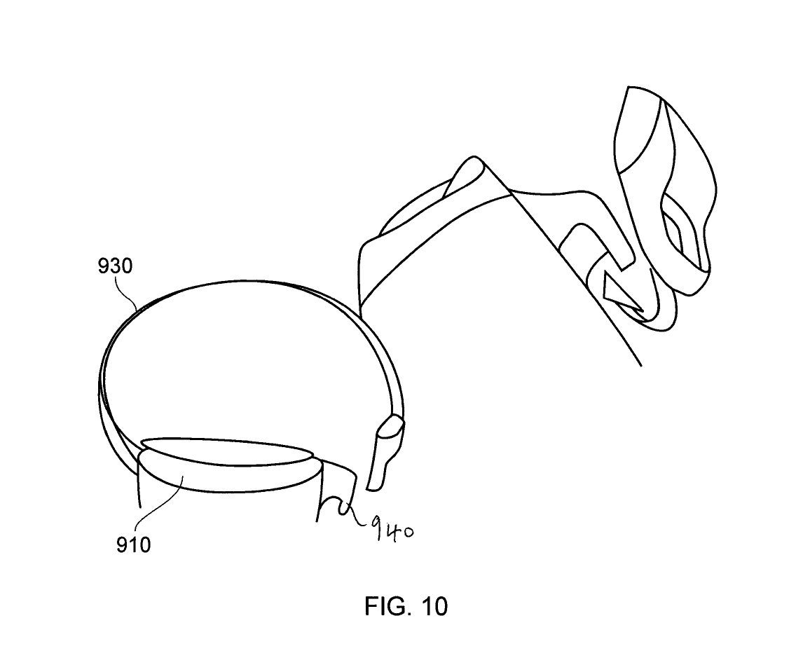

The needles are provided sterile in a sterile cartridge, which may be worn by a user, for example as shown in FIG. 10. A wristband 900 is secured about the wrist by two pairs of straps 930 so as remain fixed during use. The wristband 900 is adjustable by means of the straps 930 so as to be fitted to the practitioner's wrist.

The cartridge can be displaceably attached to the wristband by means of straps 956 and 960 and a hook and eye (Velcro—Trade Mark) connector 950.

Advantageously the wristband 900 can be rotated about the left or right wrist so as to position the cartridge in the best position for the practitioner.

In other embodiments the cartridge is provided with an integrated cartridge.

The invention has been described by way of examples only and it will be appreciated that variation may be made to the above-mentioned embodiments without departing from the scope of invention.

1. An intradermal needle comprising: a shaft, an insertion tip and a handle wherein handle depth is greater than shaft gauge so that the handle is spaced apart from skin when inserted in any orientation whereby in use the needle is prevented from lying flat on the subject's skin.

2. An intradermal needle according to claim 1 wherein the handle is in the form of a parallelepiped, cube, block, cylinder or barrel.

3. An intradermal needle according to claim 1 wherein at least one face of the handle is arcuate.

4. An intradermal needle according to claim 1 wherein the handle has a triangular cross section.

5. An intradermal needle according to claim 1 wherein the handle has a tapering cross section.

6. An intradermal needle according to claim 1 wherein the handle is coloured.

7. An intradermal needle according to claim 6 wherein the handle is coloured to indicate size.

8. An intradermal needle according to claim 1 wherein the shaft is no greater than 10 mm.

9. An intradermal needle according to claim 1 wherein the needle gauge is less than 0.18 mm.

10. An intradermal needle according to claim 1 wherein the shaft, tip and handle are formed from metal or metal alloy.

11. An intradermal needle according to claim 1 wherein the intradermal needle tip is coated for improved insertion.

12. A method of manufacturing an intradermal needle according to claim 1 in which in the intradermal needle is formed as a single part.

13. A method of manufacturing an intradermal needle according to claim 1 wherein the intradermal needle is formed from more than one part.

14. A pad for supporting the intradermal needle according to any of claim 11 when packaged wherein the pad is saturated in lubricant.

15. A wristband for supporting the pad according to claim 14.

16. A cartridge for storing a plurality of needles wherein the cartridge is capable of being mounted on a wristband for donning by a practitioner to aid in dispensing of needles.

17. An intradermal needle substantially as herein described with reference to the figures.

18. A cartridge substantially as herein described with reference to the figures.

19. A wristband substantially as herein described with reference to the figures.
